(19) United States
(12) Patent Application Publication
(10) Pub. No.: US 2007/0128917 A1
(43) Pub. Date: Jun. 7, 2007

(54) Electrical connector

(75) Inventor: Chien-Chih Ho, Keelung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Lotes Co., Ltd.

(21) Appl. No.: 11/352,203

(22) Filed: Feb. 13, 2006

(30) Foreign Application Priority Data
Dec. 2, 2005 (TW) 094220958

(51) Int. Cl. H01R 13/62

(52) U.S. Cl. 439/331

(57) ABSTRACT

An electrical connector assembly is disclosed. The electrical connector assembly is for connecting a chip module on a circuit board comprising: an insulating main body provided with an accommodating space, in which a protruding part extending inwardly and a plurality of electrical terminals maybe arranged in the accommodating space. The electrical terminal is provided with a carrier tape connecting terminal, which forms a proper angle with the side which the protruding part lies against with, to prevent carrier tape from interfering with protruding part. Compared with prior-art electrical connectors, the electrical connector according to the present invention can fold carrier tape conveniently when carrier tape being removed such that working efficiency can be enhanced.

### FIELD OF THE INVENTION

The present invention relates to an electrical connector and particularly to an electrical connector for connecting a chip module on a circuit board.

### BACKGROUND OF THE INVENTION

With the ever-changing technology, the LGA chip module has obtained increasingly wide application. At present an electrical connector comprises a base, a main body which is accommodated in the base, and a clamping plate and an actuation rod pivotedly connected to either side of the main body, wherein one side of the base is provided with a protruding part and the electrical terminals are provided with a carrier tape connecting terminal. The carrier tape connecting terminal is parallel with the extending direction of the protruding part. When the terminal is inserted into the terminal-accommodating chamber, the carrier tape has to be removed by folding downward from the carrier tape connecting terminal. Since the carrier tape connecting terminal is parallel with the extending direction of the protruding part, the carrier tape will interfere with the protruding part in the process folding downward such that the folding of the carrier tape is hindered and working efficiency is affected.

Consequently, a new electrical connector is required to overcome the shortcoming described above.

### SUMMARY OF THE INVENTION

An object of the present invention is to provide an electrical connector with which carrier tape can be conveniently folded.

To achieve the object described above, the electrical connector is for connecting a chip module on a circuit board, comprising: an insulating main body provided with an accommodating space, in which a protruding part extending inwardly; and a plurality of electrical terminals arranged in the accommodating space. The electrical terminal is provided with a carrier tape connecting terminal, which forms a proper angle with the side which the protruding part lies against with, to prevent carrier tape from interfering with protruding part when carrier material is being folded.

Compared with prior-art electrical connector, the electrical connector according to the present invention can fold carrier tape conveniently when carrier material is being removed such that working efficiency can be enhanced.

### BRIEF DESCRIPTION OF THE DRAWINGS

The present invention can be more fully understood by reference to the following description and accompanying drawings, in which:

FIG. 1; and

FIG. 1 is an assembled perspective view of a preferred embodiment of an electrical connector according to the present invention;

FIG. 2 is an exploded perspective view of a preferred embodiment of an electrical connector according to the present invention;

FIG. 3 is an exploded perspective view, taken at another angle, of a preferred embodiment of an electrical connector according to the present invention;

FIG. 4 is a plane view of the insulating main body 1 of an electrical connector according to the present invention;

FIG. 5 is a cross-sectional view of the insulating main body 1 of an electrical connector according to the present invention;

FIG. 6 is a side view of the electrical terminal 2 of an electrical connector according to the present invention;

FIG. 7 is a front view of the electrical terminal 2 of an electrical connector according to the present invention; and

FIG. 8 is a schematic illustration for the calculation of the critical angle between the carrier tape connection terminal 24 and the protruding part 15.

### DETAILED DESCRIPTION OF THE INVENTION

Further detailed explanation for the electrical connector according to the present invention will be made with accompanied figures and embodiments below.

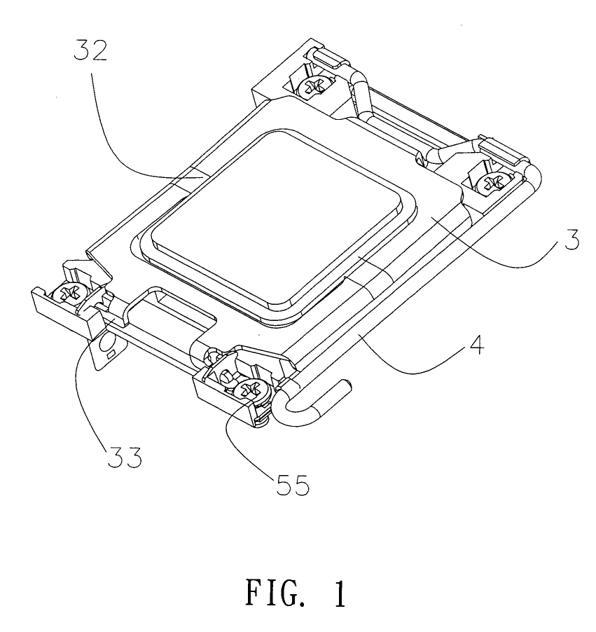

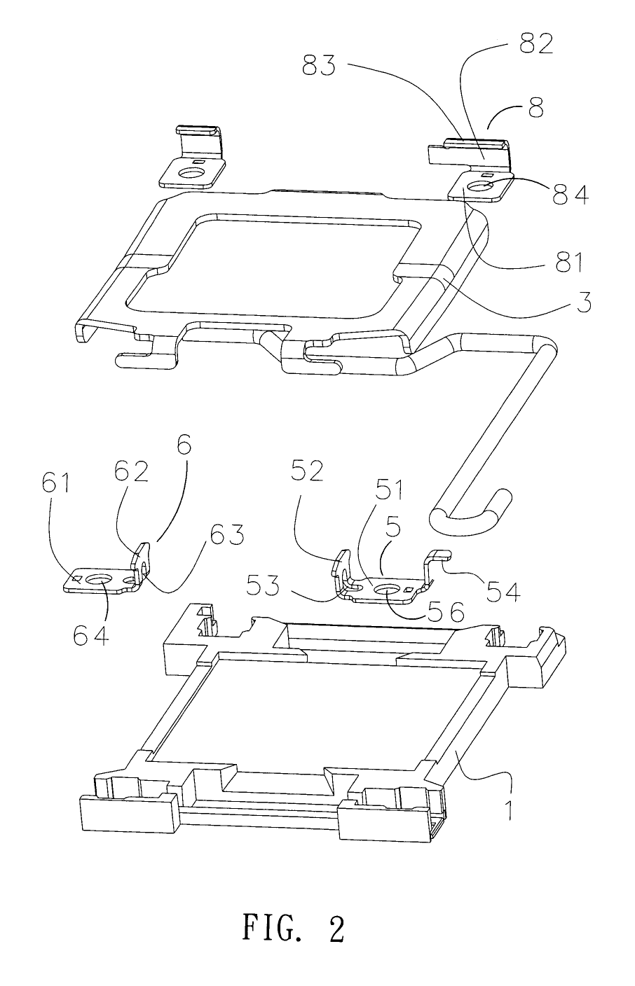

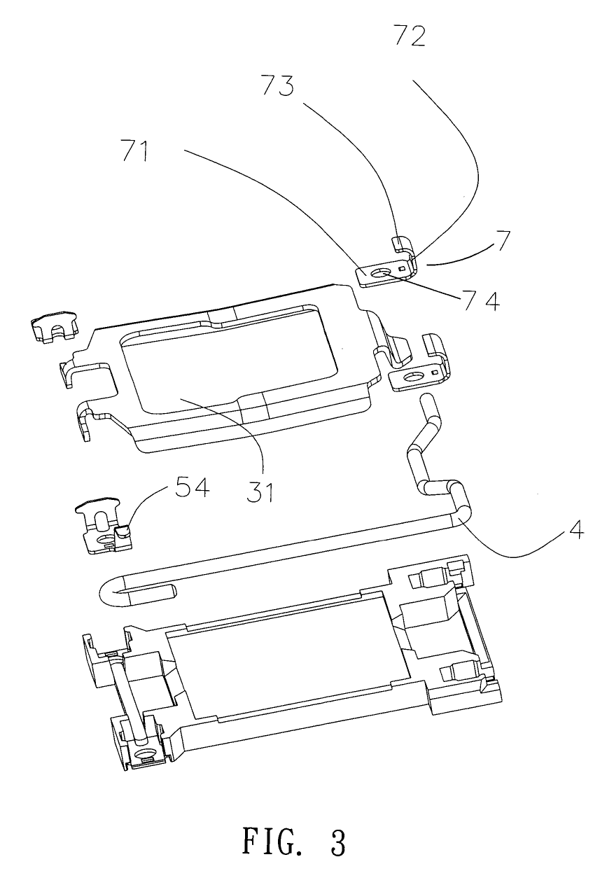

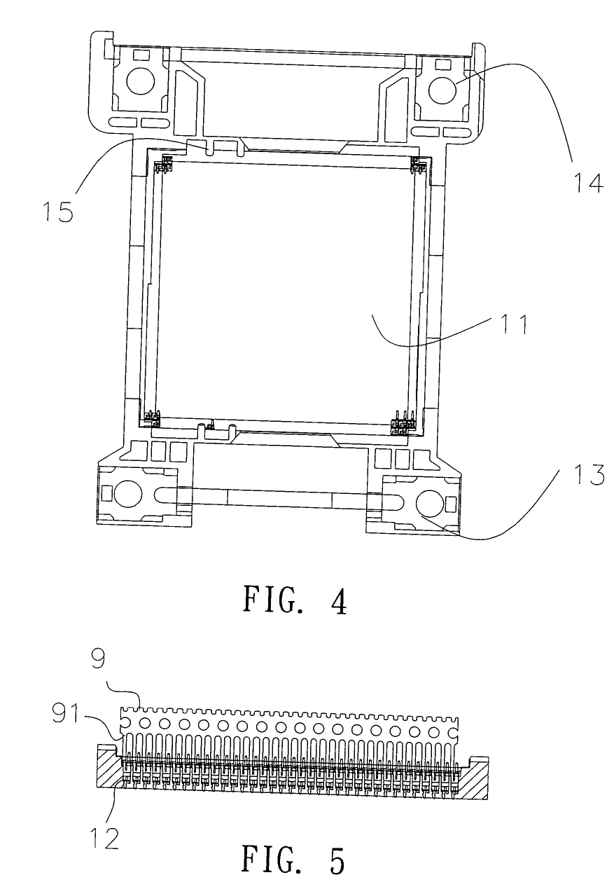

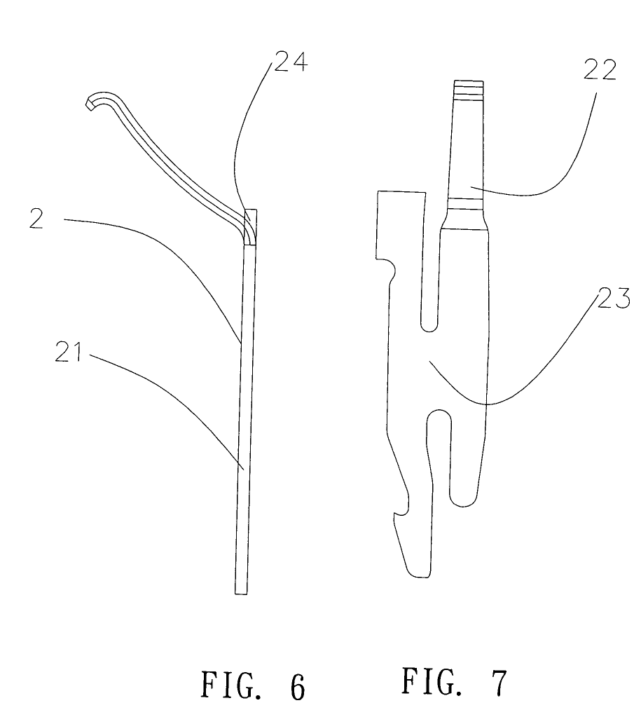

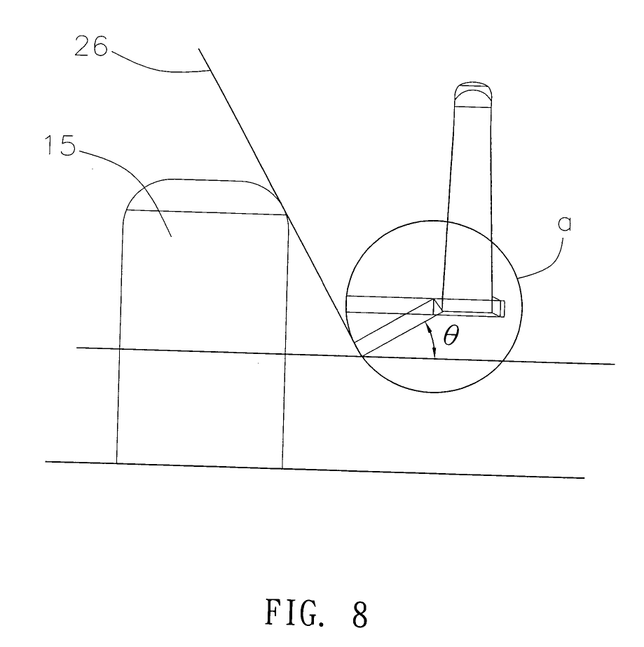

Referring to FIGS. 1 to 8, the electrical connector according to the present invention is for connecting a chip module (not shown) with a circuit board (not shown), comprising: an insulating main body 1, a plurality of electrical terminals 2, and a clamping plate 3 and an actuation rod 4 pivotedly connected to either side of the insulating main body 1. The clamping plate 3 is pivotedly connected to the insulating main body 1 through a first locating plate 5 and a second locating plate 6; the actuation rod 4 is pivotedly connected to the insulating main body 1 through a third locating plate 7 and a fourth locating plate 8. All the locating plates 5, 6, 7, and 8 may be inserted into their corresponding holes (not shown) on the insulating main body 1.

The insulating main body 1 is secured onto a circuit board with a securing device (screw 55 in the present embodiment) and is provided with an accommodating space 11 to receive a chip module. A plurality of terminal-accommodating chambers 12 are also provided in the accommodating space to receive the electrical terminals 2. Furthermore, either side of the insulating main body 1 is provided with accommodating chambers: a first accommodating chamber 13 and a second accommodating chamber 14. On one side of the insulating main body 1 is provided with a protruding part 15 to locate the chip module.

The center of the clamping plate 3 of the electrical connector is provided with a hole 31. A contacting part 32 is provided inwardly on the central part of the edge of the hole 31. When the clamping plate 3 is engaged, the contact part 32 is to contact against the chip module. Both sides of one end of the clamping plate 3 are provided with a pivoting piece 33.

The first locating plate 5 further comprises a first horizontal securing part 51 which may be secured onto the insulating main body 1, and a first vertical part 52 extending upwardly from the first horizontal part 51. The first vertical part 52 further comprises a first accommodating hole 53. Furthermore, the first locating plate 5 is further provided with a fastening hook 54 which is integrally formed with the first locating plate 5, to fasten the actuation rod 4. The second locating plate 6 further comprises a second horizontal securing part 61 and a second vertical part 62 extending upwardly from the second horizontal part 61 which may be secured onto the insulating main body 1. The second vertical part 62 is further provided with a second accommodating hole 63.

The clamping plate 3 is pivotedly connected to the insulating main body 1 through the first locating plate 5 and the second locating plate 6. The pivoting piece 33 of the clamping plate 3 is engaged with the first accommodating hole 53 of the first locating plate 5 and the second accommodating hole 63 of the second locating plate 6 to make the clamping plate 3 pivotedly connect with the insulating main body 1.

The third locating part 7 further comprises a third vertical securing part 71 which may be secured onto the insulating main body 1, a third vertical part 72 extending upwardly from the third horizontal part 71, and a third clamping part 73 bending from the top of the third vertical part 72. The fourth locating plate 8 is provided with a fourth horizontal securing part 81 which may be secured onto the insulating main body 1, a fourth vertical part 82 extending upwardly from the fourth horizontal securing part 81, and a fourth clamping part 83 bending from the top of the fourth vertical part 82.

The actuation rod 4 is pivotedly connected to the insulating main body 1 through the third locating plate 7 and the fourth locating plate 8. The actuation rod 4 is pressed against the third clamping plate 73 of the third locating plate 7 and the fourth clamping plate 84 of the fourth locating plate 8 to be pivotedly connected to the insulating main body 1. The locating plates 5, 6, 7, and 8 are provided with a small spring disc (not shown) which is stamped downwardly, respectively, to provide better connection with the insulating main body 1. Furthermore, the center of the horizontal securing parts 51, 61, 71, and 81 is provided with a through hole, 56, 64, 74, and 84 respectively, for the passage of the screw 55.

The electrical terminal 2 is accommodated in the terminal-accommodating chamber 12 of the insulating main body 1. The electrical terminal 2 further comprises a locating plate 21 which may secure the electrical terminal 2 onto the insulating main body 1 and a coordinating arm 22 to be compressively contacted with the chip module. The locating plate 21 of the electrical terminal 2 and the coordinating arm 22 of the electrical terminal 2 are on the same plane and connected together through a connecting part 23 (or a plurality of connecting parts). Furthermore, on the end of the locating plate 21 of the electrical terminal 21 is provided with a carrier tape connecting terminal 24, which forms a proper angle with the side which the protruding part 15 lies against with. The angle is preferably smaller than 30° (the degree is taken as 0° for the purpose of explanation in the present embodiment, i.e. in parallel; however, it is not limited to 0°). Consequently, when the carrier tape 9 is being folded, it will not be interfered with the protruding part 15 such that carrier tape can be conveniently folded to enhance working efficiency.

The calculation of the critical angle between the carrier tape connecting terminal 24 and the protruding part 15 is shown in FIG. 8. Take the center of the connecting part 23 as circle center and the distance between the circle center and the exterior of the carrier tape connecting terminal 24 as semi-diameter a to draw a circle. When the carrier tape 9 is being folded, the longitudinal edge exterior 26 is closest to the protruding part 15. Therefore, to prevent the carrier tape 9 from interfering with the protruding part 15 when the carrier tape 9 is being folded, the critical position of the longitudinal edge exterior 26, which is closest to the protruding part 15, is in contact with the protruding part 15. Draw a tangent line between the circle a and the arc of the round of the protruding part 15 and a line perpendicular to the tangent from the circle center. Consequently, an including angle θ can be obtained. The angle θ is the critical angle between the carrier tape connecting terminal 24 and the side which the protruding part 15 lies against with. The angle is measured to be 30° here.

The insertion of the electrical terminal 2 into the terminal-accommodating chamber 12 is through the carrier tape 9. The carrier tape 9 further comprises a sheet connecting arm 91. After the electrical terminal 2 is inserted into the terminal-accommodating chamber 12, the carrier tape 9 is folded and removed from above the sheet connecting arm 91. Consequently, when the carrier tape 9 is being folded, it will not be interfered with the protruding part 15 such that the carrier tape 9 can be conveniently folded and working efficiency can be enhanced.

While the invention has been described with reference to the a preferred embodiment thereof, it is to be understood that modifications or variations may be easily made without departing from the spirit of this invention, which is defined by the appended claims.

1. An electrical connector for connecting a chip module with a circuit board, comprising:
an insulating main body provided with an accommodating space for receiving a chip module when the chip module is inserted into the accommodating space, in which a protruding part extends inwardly from a sidewall of the insulating main body in a position to locate the chip module; and
a plurality of electrical terminals arranged in the accommodating space, wherein the electrical terminal is provided with a carrier tape connecting terminal, which forms an angle with the side which the protruding part lies against with, to prevent the carrier tape from interfering with the protruding part.

2. The electrical connector as defined in claim 1, wherein the angle between the carrier tape connecting terminal and the side which the protruding part lies against with is smaller than 30°.

3. The electrical connector as defined in claim 2, wherein the carrier tape connecting terminal is parallel with the side which the protruding part lies against with.

4. The electrical connector as defined in claim 1, wherein the electrical terminal further comprises a locating plate to secure the electrical terminal onto the insulating main body and a coordinating arm to be compressively contacted with the chip module, and the carrier tape connecting terminal is provided at the end of the locating plate.

5-6. (canceled)

7. The electrical connector as defined in claim 1, wherein the insulating main body is secured onto the circuit board with a securing device.

8. The electrical connector as defined in claim 7, wherein the securing device is a screw.

9. The electrical connector as defined in claim 1 further comprises a clamping plate and an actuation rod pivotedly connected to either side of the insulating main body.

10. The electrical connector as defined in claim 9, wherein the clamping plate is pivotedly connected to the insulating main body through a first locating plate and a second locating plate, and the first locating plate is further provided with a fastening hook which is integrally formed with the first locating plate, to fasten the actuation rod.

11. The electrical connector as defined in claim 10, wherein the first locating plate further comprises a first horizontal securing part which may be secured onto the insulating main body and a first vertical part extending upwardly from the first horizontal part, the first vertical part further comprises a first accommodating hole, the second locating plate further comprises a second horizontal securing part which may be secured onto the insulating main body and a second vertical part extending upwardly from the second horizontal part, and the second vertical part is further provided with a second accommodating hole.

12. The electrical connector as defined in claim 11, wherein the center of the first and second horizontal securing parts are provided with a through hole, respectively, for the passage of a screw.

13. The electrical connector as defined in claim 9, wherein the actuation rod is pivotedly connected to the insulating main body through a third locating plate and a fourth locating plate.

14. The electrical connector as defined in claim 13, wherein the third and fourth locating plates are provided with a vertical part, wherein the vertical part provides a clamping part by bending a top portion of the vertical part, the vertical part provides a horizontal securing part by bending a bottom portion of the vertical part, the clamping part and the horizontal securing parts are bent in the same direction.

15. The electrical connector as defined in claim 14, wherein a center of the horizontal securing part is further provided with a through hole for the passage of the securing device.

16. The electrical connector as defined in claim 1, wherein the carrier tape further comprises a sheet connecting arm.
